(19) United States
(12) Patent Application Publication
(10) Pub. No.: US 2026/0216719 A1
(43) Pub. Date: Jul. 30, 2026

(54) PIPETTOR WITH COMMON DRIVE MOTOR FOR ASPIRATION/DISPENSING AND TIP EJECTION

(71) Applicant: Mettler-Toledo Rainin, LLC, Oakland, CA (US)

(72) Inventors: Gregor Seidman, Oakland, CA (US); Christopher Brian Elginsmith, Oakland, CA (US); Srivatsan Ramesh, Fremont, CA (US)

(21) Appl. No.: 19/039,532

(22) Filed: Jan. 28, 2025

(51) Int. Cl. B01L 3/02

(52) U.S. Cl. CPC B01L 3/0227; B01L 3/0237

(57) ABSTRACT

A pipettor having a common drive motor for aspiration/dispensing and tip ejection is disclosed. A liquid end shaft has a distal end for receiving a disposable pipette tip. A drive motor is operatively connected to a piston for driving the piston axially to cause the aspiration/dispensing. A push off structure is selectively couplable to move with the piston and is driven by the drive motor to enable ejecting the disposable pipette tip received thereon from the pipettor.

### CROSS-REFERENCE TO RELATED APPLICATIONS

This application is filed as original and therefore makes no priority claim.

### TECHNICAL FIELD

Exemplary embodiments relate generally to a pipettor with a common drive motor for aspiration/dispensing and tip ejection as well as systems and methods related to the same.

### BACKGROUND AND SUMMARY OF THE INVENTION

Pipettors are known which provide for aspiration and dispensing of liquids. Some such pipettors include a motor which drives aspiration and dispensing function. Typically, pipettors work with disposable pipette tips which need removed and replaced frequently to prevent contamination. Most handheld manual and electronic pipettes have a manually operated and driven mechanism for ejecting a used disposable tip; typically, the mechanism employs a spring-biased button connected through a linkage to a push off structure, such as an eject rod coupled to an ejector sleeve or a lower portion of the housing. In general, a user pushes the eject button down to transfer force to push the tip off the pipette shaft. Because the tip is relatively securely attached to the shaft in order to prevent leakage, a considerable amount of force can be required to overcome friction and push off the tip, leading to user fatigue or an increased risk of repetitive strain injury.

Some pipettors include an automated ejection function, which is typically driven by a separate motor or a manual connection. For such pipettors, typically the tip is ejected by essentially continuing to drive an internal piston mechanism further downward compared to the normal aspiration/dispensing stroke. However, this normally requires a longer pipettor device, which is undesirable for such handheld devices that generally require repetitive, precise movements in a relatively small space.

A pipettor is disclosed which includes a common motor for driving aspiration/dispensing and tip ejection. This may result in a device with an overall smaller longitudinal length, decreased bulk, or decreased weight compared to existing solutions. This kind of configuration may also reduce the cost of manufacturing, at least compared to certain existing pipettors, as a single strong motor used to drive both dispensing and tip ejection can replace two separate drive motors. In exemplary embodiments, without limitation, the pipettor includes a drive motor and a relatively smaller eject linkage driver, such as a motor or actuator (e.g., solenoid or electromagnetic type). The drive motor may be connected to a piston, such as by way of a driven gear and a drive gear. The eject linkage driver may be connected to a selectively engageable element, such as an eject slider or other mechanism by way of non-limiting example, such as by way of a spiral cam by way of non-limiting example, or other mechanism for actuating the selectively engageable mechanism such as a rack and pinion by way of non-limiting example.

In an aspiration/dispensing configuration, the eject slider may be moved and/or maintained at a first position where the eject slider clears an ejection force transfer element (such as a flag by way of non-limiting example) connected to the piston. In this way, the piston may be driven by the drive motor to cause aspiration/dispensing of a sample, free of contact between the lead screw flag and the eject slider, thereby allowing an eject rod connected to the eject slider to remain stationary despite the piston movement. In an eject configuration, the eject slider may be moved and/or maintained at a second position where the eject slider is positioned to contact the lead screw flag. In this way, driving the piston may result in movement of the eject slider and the connected eject rod. This may drive movement of a push off structure, such as an ejector sleeve or a lower portion of the housing, relative to a mid- and/or upper portion of the housing, such as a handle body, thereby temporarily moving the push off structure along a lower portion of the shaft to force an attached tip from a distal end of the device.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical, similar, or equivalent features, and wherein:

FIG. 1 is a front perspective view of a pipettor in accordance with the present invention;

FIG. 2 is a right side view of the pipettor of FIG. 1;

FIG. 3 is a front view of the pipettor of FIG. 1;

FIG. 4 is a side section view taken along section line A-A of FIG. 3 with the pipettor in an aspiration configuration and an eject slider in a first position;

FIG. 5 is the side section view of FIG. 4 with the pipettor in a dispensing configuration and the eject slider in the first position;

FIG. 6 is the side section view of FIG. 4 with the pipettor in a first ejection switch configuration and the eject slider in the first position;

FIG. 7 is the side section view of FIG. 4 with the pipettor in a second ejection switch configuration and the eject slider in a second position;

FIG. 8 is the side section view of FIG. 4 with the pipettor in an ejection engagement configuration and the eject slider in the second position;

FIG. 9 is the side section view of FIG. 4 with the pipettor in an ejection configuration and the eject slider in the second position;

FIG. 10 is the perspective view of FIG. 1 with certain, outer components removed to reveal internal components of the pipettor;

FIG. 11 is a side view of the pipettor of FIG. 10;

FIG. 12 is a top section view taken along section line P-P of FIG. 11 with a cam in a first ejection engagement position and the eject slider in the first position;

FIG. 13 is the top section view of FIG. 12 with a cam in a second ejection engagement position and the eject slider in the first position;

FIG. 14 is a rear perspective view of the pipettor of FIG. 10;

FIG. 15 is a detailed perspective view of the Detail A area of FIG. 14 with the spiral cam in a first ejection engagement position; and

FIG. 16 is the detailed perspective view of FIG. 15 with the spiral cam in a second ejection engagement position.

### DETAILED DESCRIPTION OF EXEMPLARY EMBODIMENTS

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

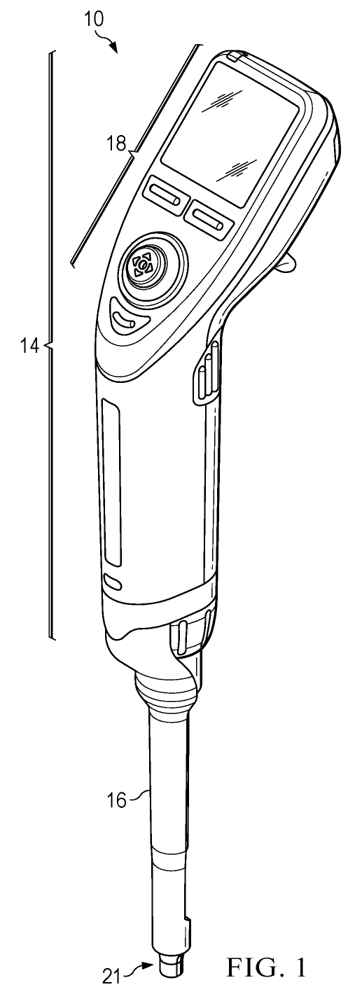

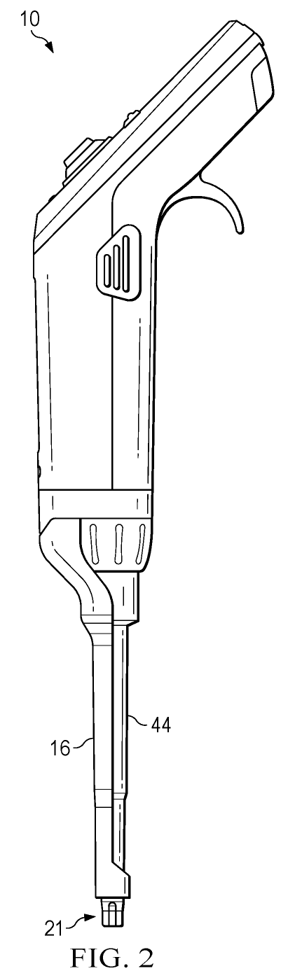

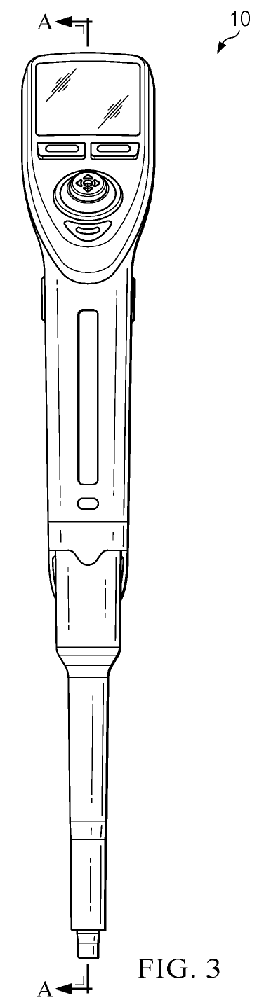

FIGS. 1 through FIG. 3 illustrate an exemplary pipettor 10 (sometimes also referred to herein as “device”). The pipettor 10 may include one or more housing components, such as panels, shells, or the like. The pipettor 10 may comprise a handle body 14. The handle body 14 may be situated above a push off structure 16 when the pipettor 10 is oriented for aspiration/dispensing (e.g., at least primarily vertical along a longitudinal axis thereof) in exemplary embodiments. The push off structure 16 may be movable relative to the handle body 14 as further shown and/or described herein. The push off structure 16 may comprise a sleeve, collar, panel, extension, rod, and/or lower portion of a housing component, by way of non-limiting example. The push off structure 16 may be moveable, such as through sliding movement and/or extension, along a liquid end shaft 44 to contact and push an attached tip off a distal end portion 21 of the liquid end shaft 44 where the tip is attached.

While a single channel pipettor 10 is sometimes shown and/or described herein, those of skill in the art will recognize that the components shown and/or described herein may be utilized with multi-channel pipettors, such as shown and/or described in US Pub. No. 2014/0199216 published July 17, 2014 (the “’216 Pub.”), the disclosures of which are hereby incorporated by reference as if fully restated herein, and the pipettor 10 may contain at least some of the components thereof. By way of non-limiting example, the push off structure 16 shown and/or described herein may be utilized with regard to the liquid end assembly 120 of the ‘216 Pub., such as to push off multiple tips at a same time.

The handle body 14 may comprise, or at least partially house and/or provide support for, a user interface 18. The user interface 18 may comprise, for example without limitation, one or more buttons, touch screens, displays, and/or other human-machine interface objects. The user interface 18 may be configured to display status information and/or accept user input for operating the pipettor 10. The user interface 18 may be mechanically and/or electronically connected to certain internal equipment further shown and/or described herein.

The handle body 14 may also at least partially enclose certain internal equipment further shown and/or described herein, such as certain mechanical components for the pipettor 10.

The distal end portion 21 of the liquid end shaft 44 may be configured to removably accept a pipette tip (not illustrated), which may be disposable, for liquid aspiration and dispensing. The distal end portion 21 of the liquid end shaft 44 may be exposed about its circumference from the push off structure 16 to receive the disposable pipette tip, at least while the pipettor is in an aspiration/dispensing configuration and/or while the pipettor is in an ejection configuration and a liquid end piston 35, which may be operable within the liquid end shaft 44, is at a maximum upstroke, such that the tip remains attached thereto. The tip may be secured to the distal end portion 21 (e.g., manually by a user) and selectively ejected therefrom by operation of the pipettor 10 as further shown and/or described herein.

As further shown/described herein, when the pipettor 10 is in the eject configuration, operation of the piston 35 may cause the push off structure 16 to slide downward along the liquid end shaft 44 to at least partially cover the distal end portion 21, thereby forcing an attached tip off the distal end portion 21, such as when the piston 35 is at a maximum downstroke. In exemplary embodiments, without limitation, at least a distal end of the push off structure 16 circumferentially surrounds the distal end portion 21 of the liquid end shaft 44, such as to form a sleeve or collar, to apply substantially (e.g., within 10%) even pressure against the tip, thereby preventing or reducing the chance of jams.

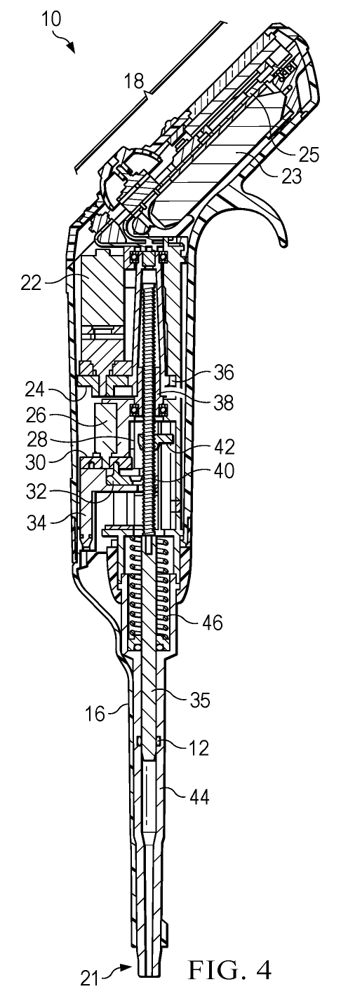

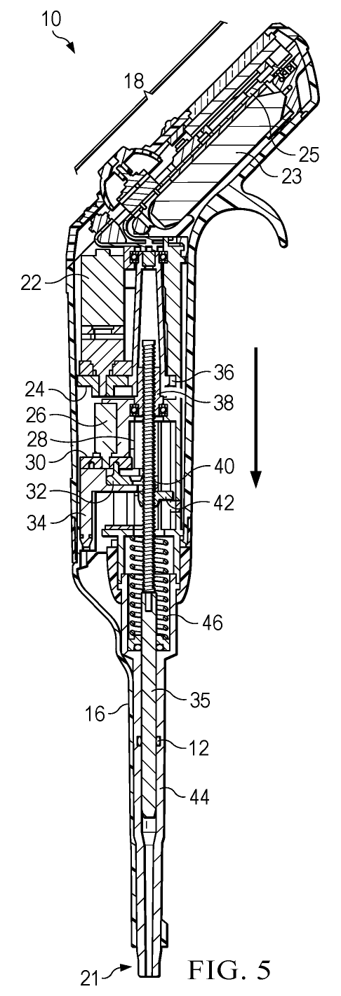

As further illustrated with particular regard to FIGS. 4 and FIG. 5, the device 10 may comprise a power supply 23, such one or more batteries, for powering the device 10. The power supply 23 may be located within the handle body 14 by way of non-limiting example. The device 10 may comprise a controller 25, such as comprising one or more printed circuit boards, non-transitory electronic storage devices, processors, combinations thereof, or the like. The controller 25 may be located within the handle body 14 by way of non-limiting example. The one or more non-transitory electronic storage devices may comprise software instructions, which when executed, are configured to cause the one or more processors to perform some or all of the operations shown and/or described herein.

The pipettor 10 may comprise a drive motor 22. The drive motor 22 may be located within the handle body 14. The drive motor 22 may be a direct current (“DC”) motor, though other types of motors may be utilized. The drive motor 22 may be mechanically connected to a drive gear 24, directly or indirectly, such as but not limited to by way of a gearbox 27 (e.g., planetary, spur) or other intermediary mechanical linkages (e.g., chain, other gears, etc.). The drive gear 24 may be mechanically connected to a driven gear 36. The driven gear 36 may be in contact with, or configured to be placed in contact with, the liquid end piston 35, such as by way of a lead nut 38 and a lead screw 40. A gear train comprising at least the drive gear 24 and the driven gear 36, as disclosed herein, may provide a reduction gear ratio that is used to reduce the speed of the drive motor 22 as applied to the lead nut 38 and lead screw 40, thereby multiplying its torque to a level sufficient for both driving the piston 35 upwards and downward for aspiration and dispensing operations and for overcoming the friction that holds the pipette tip to the shaft.

Operation of the drive motor 22 may be configured to cause rotational movement of the drive gear 24 and mechanically connected driven gear 36, and thereby also driving the piston 35 downward, such as through a seal 12. In exemplary embodiments, without limitation, the driven gear 36 may be connected to, or integrally formed with, the lead nut 38 which may be threaded to the lead screw 40 such that rotation of the driven gear 36 causes rotation of the lead nut 38. Threads of the lead nut 38 may engage complementary threads of the lead screw 40. The lead screw 40 may be connected to the piston 35, either directly or through intermediary components, such as a junction that would allow the liquid end shaft 44 and liquid end piston 35 to be removed from and reattached to the handle body 14 while ensuring the liquid end piston 35 continues to track the lead screw 40. In particular, the piston 35 may extend from and/or be connected to a distal end of the lead screw 40. The lead screw 40 and/or the piston 35 may be fixed rotationally. In exemplary embodiments, without limitation, an ejection force transfer element 42, such as a projecting lead screw flag (as illustrated), may be attached to, or integrally formed with, the piston 35 and/or the lead screw 40. The lead screw flag 42 may be fixed to the piston 35 and/or the lead screw 40, thereby preventing rotation of the piston 35 and/or the lead screw 40, such as by frictional engagement with the eject rod 34 or other component extending at least partially about the piston 35 and/or the lead screw 40 to engage the lead screw flag 42 and prevent rotation of the same. This arrangement may force the lead screw 40 to travel axially along a longitudinal axis thereof with rotation of the lead screw nut 38, thereby causing the piston 35 to travel axially with the lead screw 40. In this way, operation of the drive motor 22 may cause upward/downward movement of the piston 35. The piston 35 may be located within the liquid end shaft 44, which may contain the seal 12, such that driving the piston 35 downward, such as through the seal 12, displaces fluid within the tip to cause dispensing (e.g., FIG. 5), and conversely, retraction of the piston 35 creates a vacuum for aspirating fluid into the tip (e.g., FIG. 4), at least while the pipettor 10 is in a dispensing/aspiration configuration.

Such operations of the drive motor 22 may be controlled by the controller 25, such as in response to user actuation of one or more of the interface component(s) 18 or as programmed.

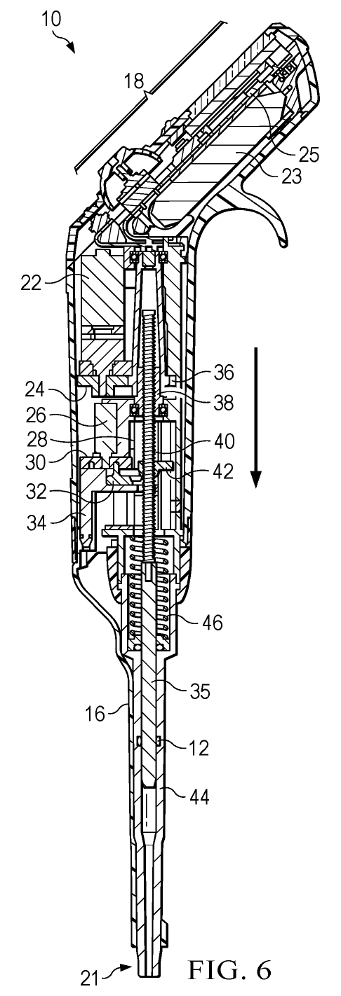

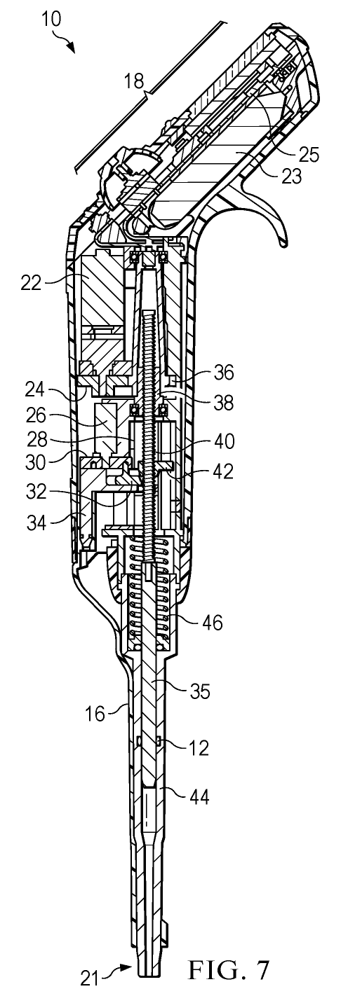

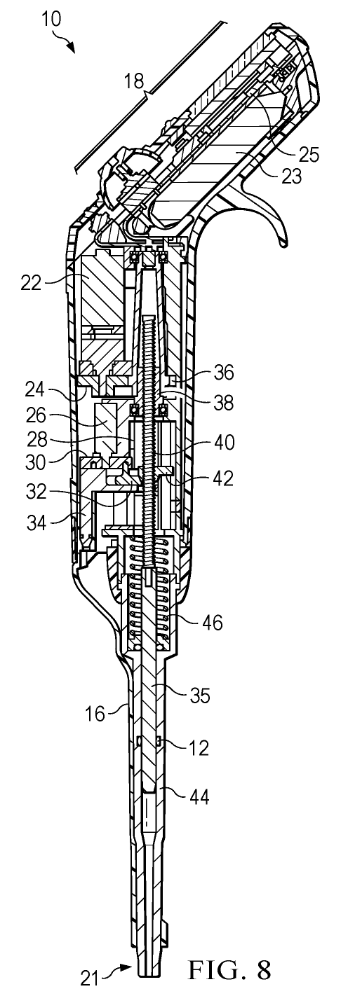

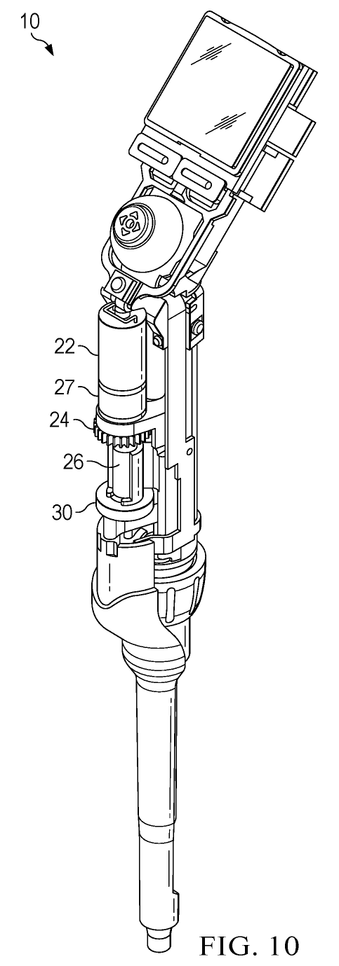

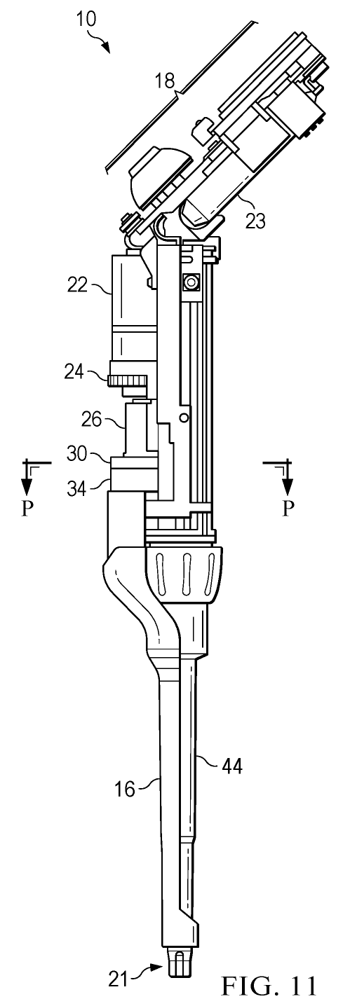

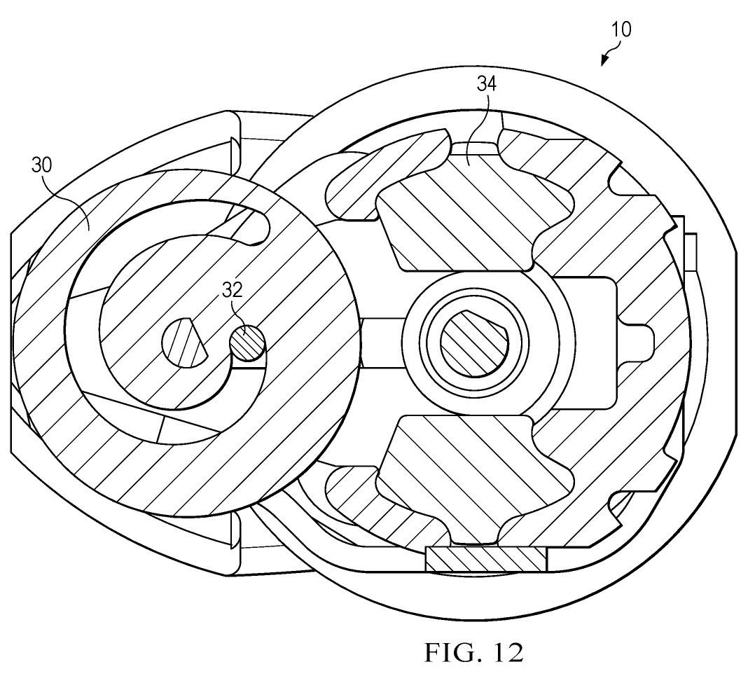

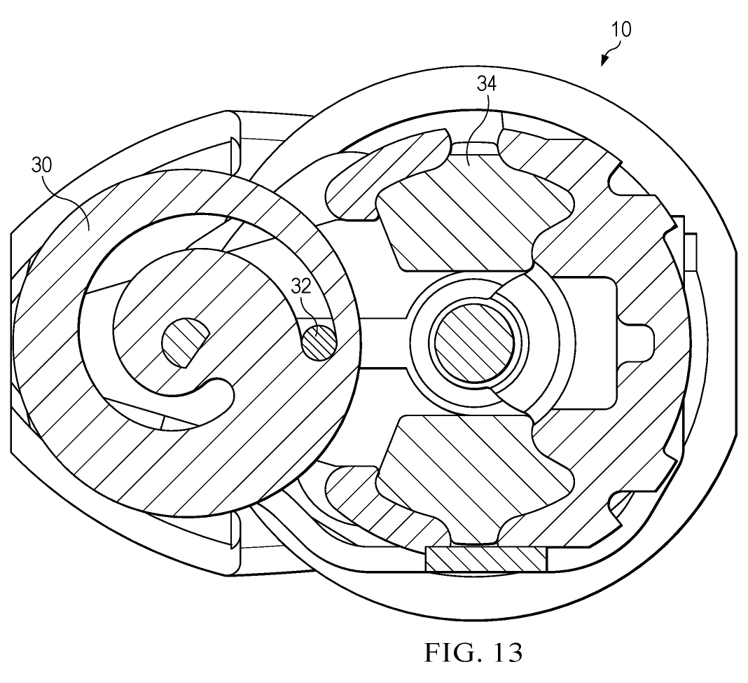

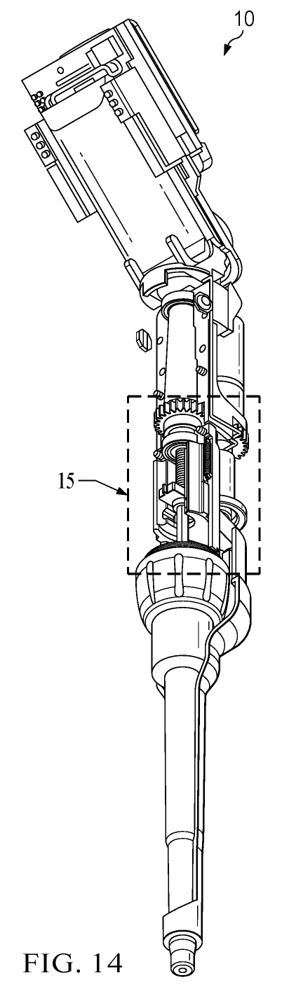

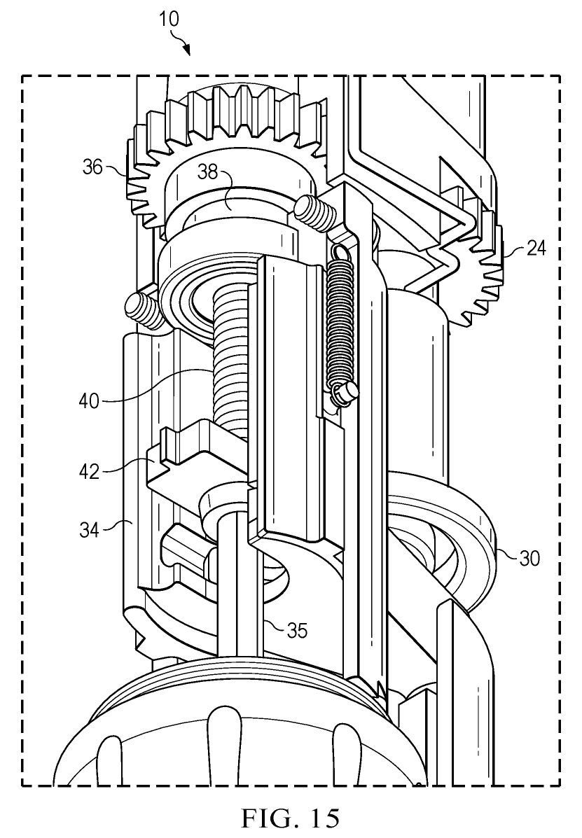

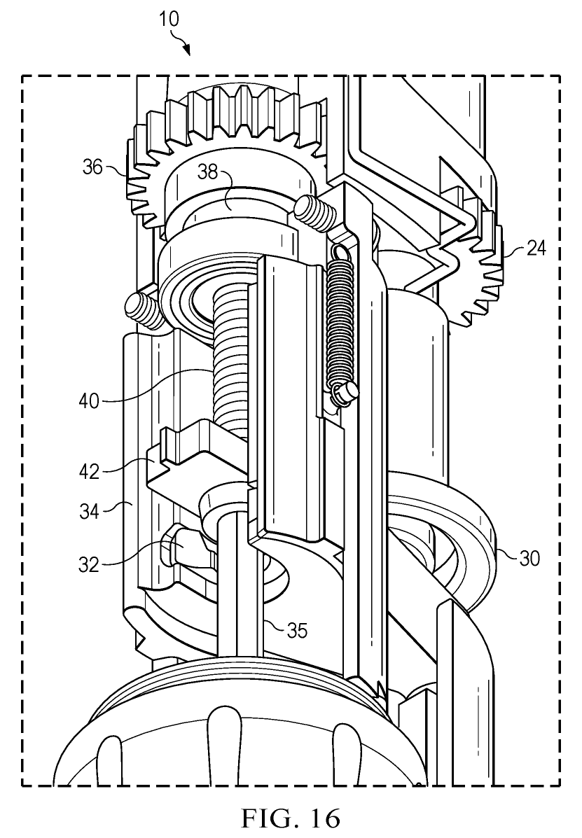

As illustrated with particular regard to FIGS. 6 through FIG. 16, upon actuation by a user of certain one or more of the interface component(s) 18, the pipettor 10 may be configured for movement between an aspiration/dispensing configuration whereby a selectively engageable element 32, such as an eject slider (as illustrated) is retracted to clear the lead screw flag 42 (e.g., FIG. 4, 5, 6, 12, 15) and an eject configuration whereby the eject slider 32 or other selectively engageable mechanism is advanced to engage the lead screw flag 42 (e.g., FIGS. 7-9, 13, 16), such as by operation of an eject linkage driver 26 in response to electronic commands issued by the controller 25. While an eject slider 32 is sometimes shown and/or described, other selectively engageable mechanisms may be utilized.

The eject linkage driver 26 may be configured to operate with sufficient torque to reliably and quickly drive the eject slider 32 or other selectively engageable mechanism between the retracted and advanced positions. In exemplary embodiments, without limitation, the eject linkage driver 26 is less than 8 mm in diameter, more preferably about 6 mm in diameter, less than 15 mm in total height, provides a load torque of at or above 0.2 mNm, a stall torque of at or above 2 mNm, operates at or about 1,200 RPM, and provides approximately one rotation per switch, which may occur in approximately 50 ms. Alternatively, a button, slider, lever, or other manually actuatable input may be provided for manually advancing and retracting the eject slider 32.

In exemplary embodiments, without limitation, the eject linkage driver 26 may be connected to a spiral cam 30 which is connected to the eject slider 32 such that operation of the eject linkage driver 26 causes movement of the spiral cam 30 and corresponding lateral movement of the eject slider 32. For example, without limitation, the spiral cam 30 may comprise a slot configured to engage a protruding portion of the eject slider 32. While a spiral cam 30 is sometimes shown and/or described, other mechanical connections may be utilized, such as a rack and pinion gear. Optionally, a eject housing 28 may be provided which at least partially surrounds at least part of the eject linkage driver 26, the lead screw 40, and/or the eject rod 34.

When in the eject configuration, the eject slider 32 may be positioned to engage with the lead screw flag 42 upon operation of the drive motor 22 and corresponding axial movement of the piston 35. When in the aspiration/dispensing configuration, the eject slider 32 may be positioned to clear the lead screw flag 42 upon operation of the drive motor 22 and corresponding axial movement of the piston 35 such that the piston 35 moves without contact between the lead screw flag 42 and eject slider 32.

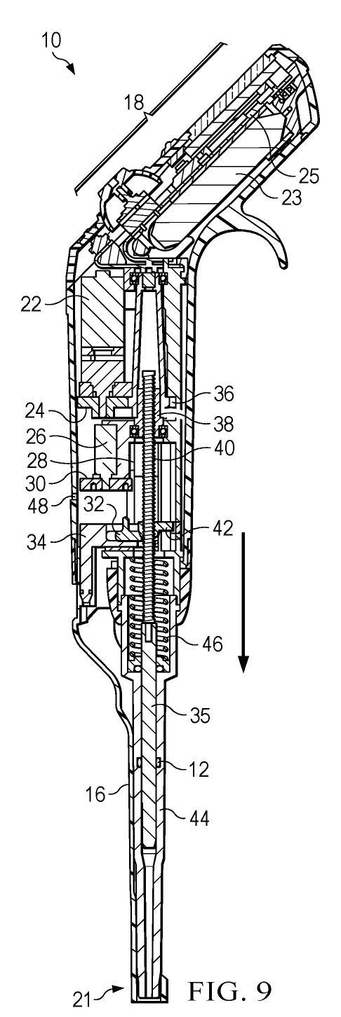

The eject slider 32 may be mechanically connected to, or integrally formed with, an eject rod 34. The eject rod 34 may be in contact with, configured to contact, be connected to, and/or be integrally formed with, the push off structure 16. In this fashion, when in the eject slider engaged configuration, the lead screw flag 42 may engage the eject slider 32 upon downward movement of the piston 35, thereby resulting in downward movement of the eject rod 34 (e.g., FIG. 9), thereby driving movement of the push off structure 16 relative to the handle body 14 of the pipettor 10 and/or the liquid end shaft 44, both of which may be relatively fixed, resulting in displacement of the tip from the distal end portion 21. In this way, ejection may be accomplished by essentially reusing the lead screw 40 and piston 35 travel that is otherwise used for aspiration and dispensing, thus preventing the need to lengthen the device 10. Furthermore, while a separate eject linkage driver 26 may be utilized in certain embodiments, the driving motion for aspiration/dispensing and tip ejection may be provided by the drive motor 22.

When ejection is desired, the tip is generally empty of fluid following a dispense operation, so downward motion of the piston 35 associated with operation of the drive motor 22 will still cause the piston 35 to move downward through a seal 12 (e.g., o-ring, lip seal) in the liquid end 44, but without fluid the effect of this will not be significant. If, through programming of the controller 25, it is determined that some fluid remains in the tip, such as by way of sensor data, the controller 25 may be configured to cause the user interface 18 to indicate to the user, such as by visual display, that a final fluid discharge dispensing operation may be required before the tip can be ejected and/or automatically cause said final fluid discharge dispensing operation.

In exemplary embodiments, without limitation, the push off structure 16 and/or the eject rod 34 may be connected to the handle body 14 by way of one or more springs 46. In this way, the push off structure 16 and handle body 14, may be biased for movement towards each other.

After completing the ejection movement, the pipettor 10 may be further operated to return the device 10 to the aspiration/dispense configuration, including by operating the drive motor 22 to return the piston 35 upward, thereby allowing the push off structure 16 to move upward, exposing the distal end portion 21 (e.g., to receive a new tip), and activating the eject linkage driver 26 to cause disengagement of the eject slider 32, thereby clearing the lead screw flag 42 so that the pipettor 10 may return to a dispensing/aspirating configuration and operation.

In this way, the pipettor 10 utilizes a common drive motor (i.e., drive motor 22) for driving movement of the pipettor 10 for aspiration/dispensing as well as ejection. Multiple operations in the dispense/aspiration configuration and/or eject configuration may be undertaken.

In exemplary embodiments, without limitation, the eject slider 32 is disengaged from the spiral cam 30 when the pipettor 10 is in the eject configuration and the eject slider 32 is undertaking vertical travel. This is due to the axially travel of the piston 35 and connected eject slider 32, thereby separating the eject slider 32 from the spiral cam 30 during at least part of the eject travel. The eject slider 32 must re-engage with the spiral cam 30 before the eject linkage driver 26 can act upon it, such as to move the pipettor 10 into aspiration/dispense configuration.

To assist with re-engagement of the eject slider 32 with the spiral cam 30, the lead screw flag 42 and/or the ejector slider 32 may be configured to prevent or inhibit the eject slider 32 from lateral movement, thereby avoiding unintended disengagement of the ejector slider 32 from the lead screw flag 42 while the lead screw flag 42 is pushing down on the eject slider 32. It is notable that the eject slider 32 is biased upwards against the lead screw flag 42 by the eject rod 34, which is turn is biased upwards by the spring 46. In exemplary embodiments, without limitation, the lead screw flag 42 to eject slider 32 connection comprises a cone in cone connection, such as a protruding cone from a surface of the lead screw flag 42 and a recessed cone extending into a surface of the eject slider 32 configured to accept the protruding cone of the lead screw flag 42 in a mating arrangement, or vice-versa, thereby preventing, or at least inhibiting, the eject slider 32 from lateral disengaging movement, such as during vertical travel, but allowing vertical separation, such as when needed to allow lateral movement of the eject slider 32.

Alternatively, or additionally, the pipettor 10 may include a home position sensor 48 configured to confirm that the lead screw 40, piston 35, and/or other component(s) has returned to the correct position, such as for the aspiration/dispensing configuration, before eject linkage driver 26 is actuated. In exemplary embodiments, without limitation, the sensor 48 data is provided to the controller 25 which operationally controls the eject linkage driver 26, such as based, at least in part, on the data from the sensor 48. The sensor 48 may comprise a limit switch, proximity sensor, optical sensor, combinations thereof, or the like. More than one sensor 48 of a same or different type may be utilized, such as to monitor the location of various components (e.g., eject slider 32, spiral cam 30, piston 35, combinations thereof, or the like). If data received from the sensor 48 indicates the eject rod 34 has not reached the home sensor position 48, the controller 25 may be configured to determine that the eject slider 32 has not engaged properly with the spiral cam 30. The controller 25 may be configured to actuate the eject linkage driver 26, such as in a back-and-forth motion, thereby allowing the eject slider 32 to engage with the spiral cam 30.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

Certain operations described herein may be performed by one or more electronic devices. Each electronic device may comprise one or more processors, electronic storage devices, executable software instructions, combinations thereof, and the like configured to perform the operations described herein. The electronic devices may be general purpose computers or specialized computing devices. The electronic devices may comprise personal computers, smartphones, tablets, databases, servers, or the like. The electronic connections and transmissions described herein may be accomplished by one or more wired or wireless connectively components (e.g., routers, modems, ethernet cables, fiber optic cables, telephone cables, signal repeaters, and the like) and/or networks (e.g., internets, intranets, cellular networks, the world wide web, local area networks, and the like). The computerized hardware, software, components, systems, steps, methods, and/or processes described herein may serve to improve the speed of the computerized hardware, software, systems, steps, methods, and/or processes described herein. The electronic devices, including but not necessarily limited to the electronic storage devices, databases, controllers, or the like, may comprise and/or be configured to hold, solely non-transitory signals.

What is claimed is:

1. A pipettor having a common drive motor for aspiration/dispensing and tip ejection, said pipettor comprising:
a piston;
a liquid end shaft having a distal end for receiving a disposable pipette tip;
a drive motor operatively connected to the piston for driving the piston axially to cause the aspiration/dispensing; and
a push off structure that is selectively couplable to move with the piston driven by the drive motor to enable ejecting the disposable pipette tip received thereon from the pipettor.

2. The pipettor of claim 1 further comprising:
a spring connecting the push off structure to the handle body to bias the push off structure towards the handle body.

3. The pipettor of claim 1 wherein:
the push off structure comprises an ejector sleeve extending about a portion of the liquid end shaft.

4. The pipettor of claim 1 further comprising:
a lead nut coupled to be driven by the drive motor;
a lead screw threaded to the lead nut, wherein the piston is connected to the lead screw;
a selectively engageable element movable between:
a first element position in which the selectively engageable element engages an ejection force transfer element coupled to the lead screw or the piston to allow the drive motor to operate the push off structure by causing the push off structure to move with the piston; and
a second element position in which the selectively engageable element clears the ejection force transfer element and the drive motor does not operate the push off structure.

5. The pipettor of claim 4 wherein:
the selectively engageable element comprises an eject slider.

6. The pipettor of claim 5 wherein:
the ejection force transfer element comprises a lead screw flag.

7. The pipettor of claim 6 wherein the drive motor is coupled to the lead nut through a drive gear connected to the drive motor and a driven gear connected to the drive gear and lead nut.

8. The pipettor of claim 7 wherein:
the mechanical connection between the drive motor and the piston comprises:
a drive gear rotationally coupled to the drive motor;
a driven gear rotationally coupled to the drive gear;
a lead nut rotationally coupled to the driven gear; and
a lead screw connected to the piston, wherein the lead screw is fixed rotationally such that rotation of the lead nut causes axial movement of the piston.

9. The pipettor of claim 8 further comprising:
a cam selectively mechanically coupled to an eject linkage driver and to the eject slider, at least when the piston is in a home position, wherein the eject linkage driver is operable to move the eject slider between the first eject slider position and the second eject slider position.

10. The pipettor of claim 9 wherein the cam comprises a spiral cam.

11. The pipettor of claim 6 further comprising:
a protrusion extending from one of the eject slider and the lead screw flag; and
a recess complementary to the protrusion located in the other one of the eject slider and the lead screw flag, wherein the protrusion and recess are mated when the eject slider is in the first eject slider position.

12. The pipettor of claim 11 wherein:
the protrusion comprises a cone shape.

13. The pipettor of claim 6 wherein:
the liquid end shaft at least partially encloses the piston; and
the pipettor further comprises a seal located within the liquid end shaft, wherein the piston extends, at least in part, through the seal, and wherein a distal end of the liquid end shaft is exposed from the ejector sleeve at least when the piston is at the maximum upstroke.

14. The pipettor of claim 13 wherein:
the push off structure, at least when the eject slider is in the first eject slider position and the piston is at a maximum downstroke, at least partially covers a distal end portion of the liquid end shaft.

15. The pipettor of claim 14 wherein:
at least a distal end of the push off structure circumferentially surrounds the distal end portion of the liquid end shaft.

16. The pipettor of claim 6 further comprising:
a user interface configured to accept input for operating the pipettor; and
a controller in electronic communication with the drive motor and an eject linkage driver operable to move the eject slider between the first eject slider position and the second eject slider position, said controller comprising one or more non-transitory electronic storage devices comprising software instructions, which when executed, configure one or more processors of the controller to:
receive data indicating user input at the user interface; and
operate the drive motor and the eject drive in accordance with the received data.

17. The pipettor of claim 16 wherein:
the user input comprises a request to place the pipettor in one of: an aspiration/dispense configuration and an eject configuration; and
the controller is configured to command the eject linkage driver to actuate to place the eject slider in the second eject slider position when the user input comprises a request to place the pipettor in the aspiration/dispense configuration, and to command the eject linkage driver to actuate to place the eject slider in the first eject slider position when the user input comprises a request to place the pipettor in the eject configuration.

18. The pipettor of claim 17 wherein:
the user interface comprises at least one electronic display and at least one user operable button; and
the pipettor further comprises one or more batteries electrically connected to the user interface, the drive motor, and the eject linkage driver.

19. The pipettor of claim 16 wherein:
the drive motor is a direct current motor; and
the eject linkage driver comprises a motor configured to provide a smaller level of maximum torque than the drive motor.

20. A pipettor having a common drive motor for aspiration/dispensing and tip ejection, said pipettor comprising:
a housing, said housing including a first portion and a second portion which are configured for relative movement;
a piston;
a liquid end shaft having an end portion for receiving a disposable pipette tip, wherein the piston resides at least in part within the liquid end shaft;
a lead screw flag connected to the piston;
a drive motor operatively connected to the piston by way of at least a drive gear and driven gear for driving the piston;
an eject linkage driver operatively connected to an eject slider by way of at least a spiral cam for selectively moving the eject slider between a second position where the eject slider clears the lead screw flag upon movement of the piston and a first position where the eject slider contacts and moves with the lead screw flag upon movement of the piston; and
an eject rod connected to the eject slider such that operation of the drive motor when the eject slider is in the second eject slider position is configured to cause translation of the piston within the liquid piston end without movement of the eject rod as part of an aspiration/dispense mode, and, operation of the drive motor when the eject slider is in the first eject slider position is configured to cause translation of the piston within the liquid piston end and translation of the eject rod to cause translation of the push off structure along the liquid piston end, thereby temporarily covering the end portion of the liquid end shaft and ejecting any disposable pipette tip attached thereto as part of an ejection mode.

21. The pipettor of claim 20 further comprising:
a user interface configured to accept input for operating of the pipettor; and
a controller which is electronically connected to the eject linkage driver and the drive motor, said controller comprising one or more processors and one or more non-transitory electronic storage devices comprising software instructions, which when executed, configure the one or more processors to:
in response to receipt of data from the user interface indicating activation of the aspiration/dispensing mode, command the drive motor and/or the eject linkage driver to cause movement of the piston while the eject slider is in the second eject slider position; and
in response to receipt of data from the user interface indicating activation of the eject mode, command the drive motor and/or eject linkage driver to cause movement of the piston while the eject slider is in the first eject slider position.

22. The pipettor of claim 21 further comprising:
a spring connecting the push off structure to the handle body such that the handle body and the push off structure are biased toward one another and the distal end of the liquid end piston is normally exposed.

23. A pipettor having a common drive motor for aspiration/dispensing and tip ejection, said pipettor comprising:
a housing and a push off structure which are configured for relative movement;
a user interface configured to accept input for operating of the pipettor;
a piston;
a liquid end shaft having a distal end portion for receiving a disposable pipette tip, wherein the piston resides at least in part within the liquid end shaft;
a lead screw flag connected to the piston;
a drive motor operatively connected to the piston by way of at least a drive gear and driven gear for driving the piston;
an eject linkage driver operatively connected to an eject slider by way of at least a spiral cam for selectively moving the eject slider between a second eject slider position where the eject slider clears the lead screw flag upon movement of the piston and a first eject slider position where the eject slider contacts and moves with the lead screw flag upon movement of the piston;
an eject rod connected to the eject slider such that operation of the drive motor when the eject slider is in the second eject slider position is configured to cause translation of the piston within the liquid end shaft without movement of the eject rod as part of an aspiration/dispense mode, and, operation of the drive motor when the eject slider is in the first eject slider position is configured to cause translation of the piston within the liquid piston end and translation of the eject rod to cause translation of the push off structure along the liquid end shaft, thereby temporarily covering at least part of the end portion of the liquid end shaft and ejecting any disposable pipette tip attached thereto as part of an ejection mode;
a controller which is electronically connected to the eject linkage driver and the drive motor, said controller comprising one or more processors and one or more non-transitory electronic storage devices comprising software instructions, which when executed, configure the one or more processors to:
in response to receipt of data from the user interface indicating activation of the aspiration/dispensing mode, command the drive motor and/or the eject linkage driver to cause movement of the piston while the eject slider is in the second eject slider position; and
in response to receipt of data from the user interface indicating activation of the eject mode, command the drive motor and/or eject linkage driver to cause movement of the piston while the eject slider is in the first eject slider position;
a power source comprising one or more batteries, said power source in electrical connection with the controller, the drive motor, and the eject linkage driver; and
a spring connecting the push off structure to the handle body such that the handle body and the push off structure are biased toward one another and the distal end of the liquid end piston is normally exposed.
